(19) United States
(12) Patent Application Publication
(10) Pub. No.: US 2017/0330712 A1
(43) Pub. Date: Nov. 16, 2017

(54) KEY ASSEMBLY

(71) Applicants: LITE-ON ELECTRONICS (GUANGZHOU) LIMITED, GUANGZHOU (CN); LITE-ON TECHNOLOGY CORPORATION, TAIPEI CITY (TW)

(72) Inventor: Chun-Lin Chen, TAIPEI CITY (TW)

(21) Appl. No.: 15/595,695

(22) Filed: May 15, 2017

Related U.S. Application Data
(60) Provisional application No. 62/336,782, filed on May 16, 2016.

(51) Int. Cl. H01H 21/24; H01H 21/40; H01H 13/705; H01H 21/22; H01H 13/12; H01H 21/36; H01H 21/18

(52) U.S. Cl. CPC H01H 21/24; H01H 13/705; H01H 21/40; H01H 21/18; H01H 13/12; H01H 21/36; H01H 21/22

(57) ABSTRACT

A key assembly to be installed on a keyboard is provided. The key assembly includes a base plate including a snap-fit hook, a scissor member including a pivot shaft, and a keycap. The keycap is disposed on the scissor member and connected thereto. The scissor member is disposed on the base plate and connected thereto. A bending portion of the snap-fit hook has a chamfer structure to which the pivot shaft is pivotally connected in such a manner that the vertical gap between the snap-fit hook and the pivot shaft is reduced.

### BACKGROUND OF THE INVENTION

### 1. Field of the Invention

The present disclosure relates to a key assembly; more particularly, to a key assembly that prevents the bottom portion of the keycap from moving unstably.

### 2. Description of Related Art

A conventional key assembly includes a keycap, a scissor member, and a base plate, in which the scissor member is disposed between the base plate and the keycap so as to support the keycap, keeping the keycap in balance and enabling the keycap to move up and down relative to the base plate. However, the gap between the scissor member and the base plate often causes the bottom portion of the keycap to move unstably when the keycap is pressed.

One of the prior art solutions is to utilize the tolerance variations of the snap-fit hook of the base plate to reduce the level of tilting and quivering. Nevertheless, the existence of tolerance variations results in gaps between parts, which still cause the keycap to quiver during typing. An enormous amount of manpower is thus required to repeatedly adjust the tolerance in height until the gaps are completely eliminated, inducing high financial costs and difficulties in making a precise mold.

### SUMMARY OF THE INVENTION

Accordingly, the object of the present disclosure is to provide a key assembly, which includes components with conventional tolerance variations but still adopts structural means that reduces unstable actuation at the bottom of the keycap.

In order to achieve the aforementioned objects, the present disclosure provides a key assembly to be installed on a keyboard, the key assembly including: a base plate having a snap-fit hook, a scissor member having a pivot shaft, and a keycap. The keycap is disposed on the scissor member and connected thereto. The scissor member is disposed on the base plate and connected thereto. A bending portion of the snap-fit hook has a chamfer structure to which the pivot shaft is pivotally connected in such a manner that the vertical gap between the snap-fit hook and the pivot shaft is reduced.

The present disclosure is advantageous in that the snap-fit hook has a chamfer structure at a bending portion thereof, and the pivot shaft is pivotally connected to the snap-fit hook and abuts the chamfer structure by being in point contact therewith so that the vertical gap between the snap-fit hook and the pivot shaft can be reduced. By the aforementioned technical means, the key assembly of the present disclosure reduces the unstable actuation at the bottom of the keycap while using components with conventional tolerance dimensions.

In order to further the understanding of the present disclosure, the following embodiments are provided along with illustrations to facilitate the disclosure of the present disclosure.

### BRIEF DESCRIPTION OF THE DRAWINGS

FIG. 1 is a perspective view illustrating a key assembly according to one embodiment of the present disclosure.

FIG. 2 is an exploded perspective view illustrating the key assembly according to one embodiment of the present disclosure.

FIG. 3 is an exploded perspective view illustrating the key assembly of the present disclosure from another point of view.

FIG. 4 is a sectional view of the key assembly according to one embodiment of the present disclosure.

FIG. 5 is a fragmentary enlarged view of the key assembly of FIG. 4.

FIG. 6 is a fragmentary schematic view illustrating a portion of FIG. 5.

FIG. 7 is another fragmentary enlarged view of the key assembly of FIG. 4.

FIG. 8 is a fragmentary schematic view illustrating a portion of FIG. 7.

FIG. 9 is another fragmentary enlarged view illustrating a portion of a key assembly according to one embodiment of the present disclosure.

### DETAILED DESCRIPTION OF THE PREFERRED EMBODIMENTS

The aforementioned illustrations and following detailed description are exemplary for the purpose of further explaining the scope of the present disclosure. Other objectives and advantages related to the present disclosure will be illustrated in the following description and appended drawings. Furthermore, the directional terms such as “left”, “right”, “upper” or “lower” are used for the purpose of describing the drawings and shall not be deemed as limitations to the present disclosure.

It should be understood that, although terms such as “first” and “second” are used to describe the components of the present disclosure in the description below, the components are not limited by these terms. Instead, the use of these terms is merely for the purpose of distinguishing components from each other. On the other hands, the term “or” may indicate that any one of the listed items or all the possible combinations thereof are included.

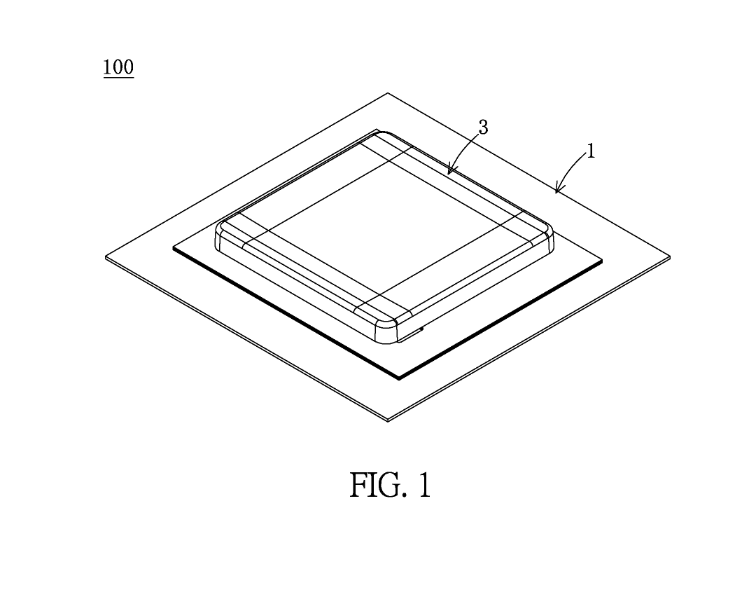

Referring to FIG. 1 to FIG. 5, the present disclosure provides a key assembly 100 to be installed on a keyboard, such as an ultra-thin keyboard. However, the present disclosure is not limited thereto. The key assembly 100 includes a base plate 1, a scissor member 2, and a keycap 3. The keycap 3 is disposed on the scissor member 2 and connected thereto, and the scissor member 2 is disposed on the base plate 1 and connected thereto.

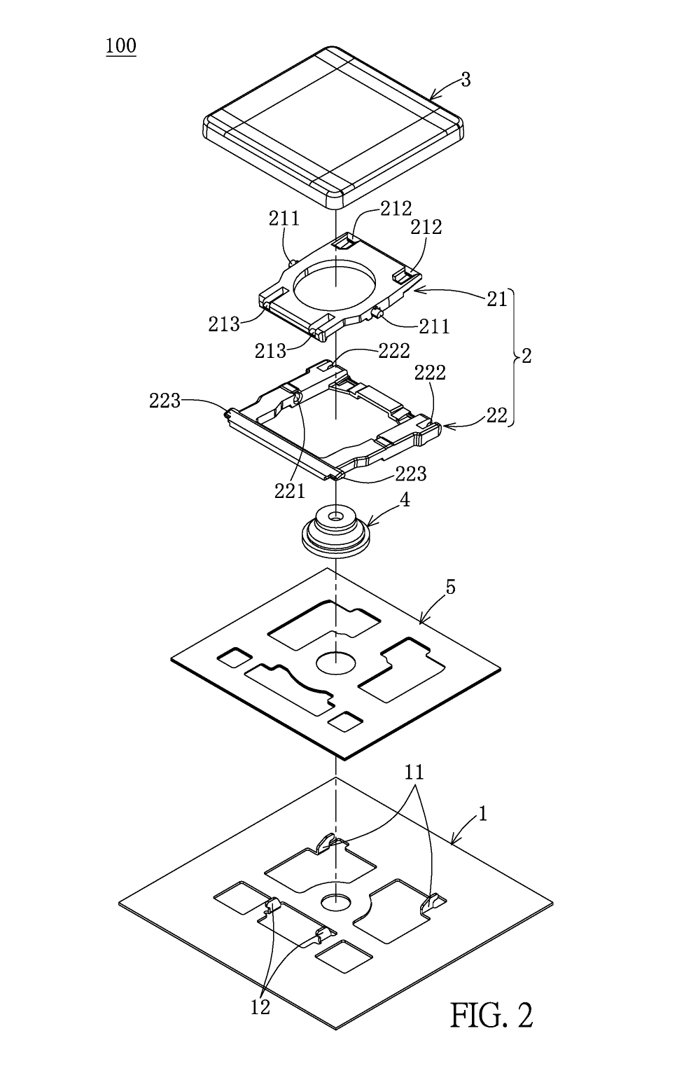

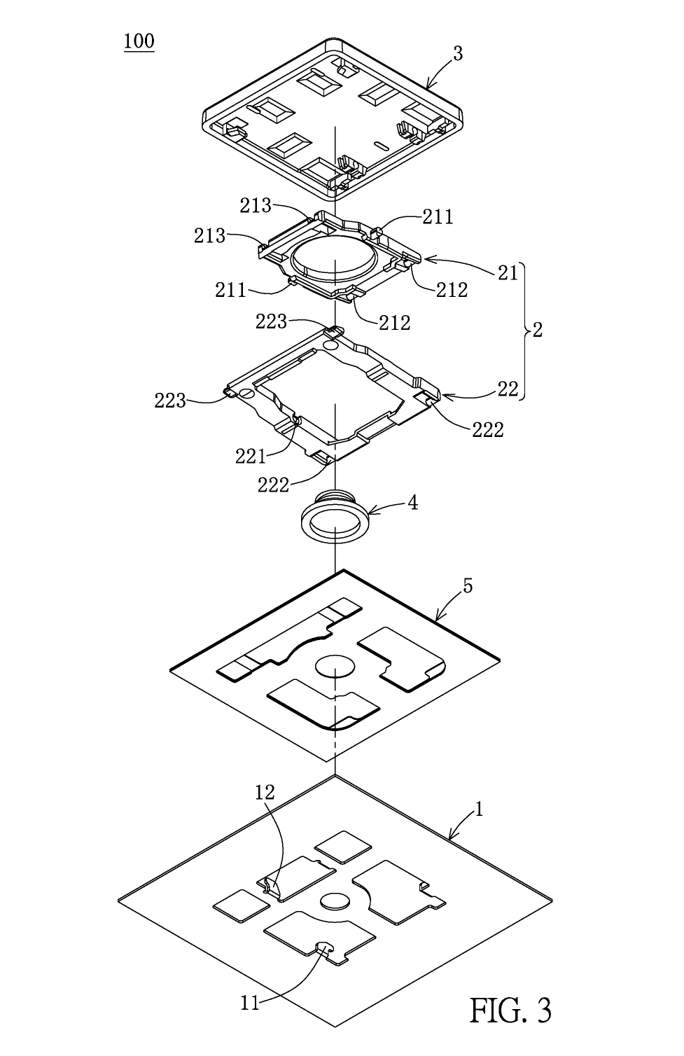

Furthermore, with reference to FIGS. 2 and 3, the key assembly 100 can also include an elastic body 4 and a thin film circuit board 5. The elastic body 4 is disposed between the keycap 3 and the base plate 1 and supports the keycap 3 in a manner such that the keycap 3 moves vertically relative to the base plate 1. The thin film circuit board 5 is disposed between the elastic body 4 and the base plate 1, generating driving signals when pressed by the elastic body 4.

The scissor member 2 includes a first frame 21 and a second frame 22 that are assembled together and form an X shape. The first frame 21 and the scissor member 2 can swing relative to each other. The first frame 21 includes a connecting shaft 211, and the second frame 22 includes a shaft opening 221. The first frame 21 is rotatably connected to the second frame 22 with the connecting shaft 211 being accommodated in the shaft opening 221. A rotation axis passes through the connecting shaft 211 and the shaft opening 221.

The first frame 21 further includes at least one pivot shaft 212 and at least one sliding shaft 213 respectively disposed at both sides of the rotation axis. The second frame 22 includes at least one pivot shaft 222 and at least one sliding shaft 223 respectively disposed at both sides of the rotation axis. In the present embodiment, the first frame 21 includes two pivot shafts 212 and two sliding shafts 213, and the second frame 22 includes two pivot shafts 222 and two sliding shafts 223. The pivot shafts 212 of the first frame 21 and the sliding shafts 223 of the second frame 22 are connected to the keycap 3. The sliding shafts 213 of the first frame 21 and the pivot shafts 222 of the second frame 22 are connected to the base plate 1. However, the present disclosure is not limited thereto. A person skilled in the art can design the scissor member 2 according to actual needs.

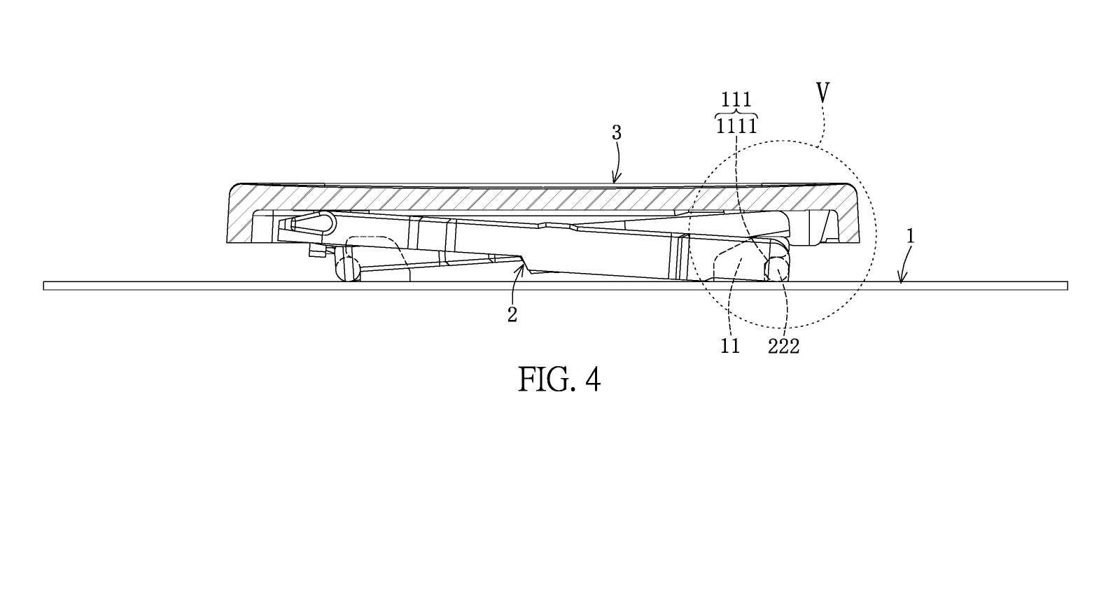

The base plate 1 can be made of metal plate or other suitable materials. The base plate 1 includes a fixing end and a sliding end disposed on opposite sides thereof. The fixing end and the sliding end respectively include a snap-fit hook 11 and 12, which are formed by a stamping process into an upside-down L shape and which are protruded from the base plate 1 and integrally connected thereto. The snap-fit hook 12 located at the sliding end is connected to the sliding shaft 213 of the first frame 21, and the snap-fit hook 11 located at the fixing end is connected to the pivot shaft 222 of the second frame 22. Referring to FIG. 4, the snap-fit hook 11 at the fixing end includes a chamfer structure 111. The pivot shaft 222 of the scissor member 2 can be pivotally connected to the snap-fit hook 11 and abuts the chamfer structure 111 by being in point contact therewith.

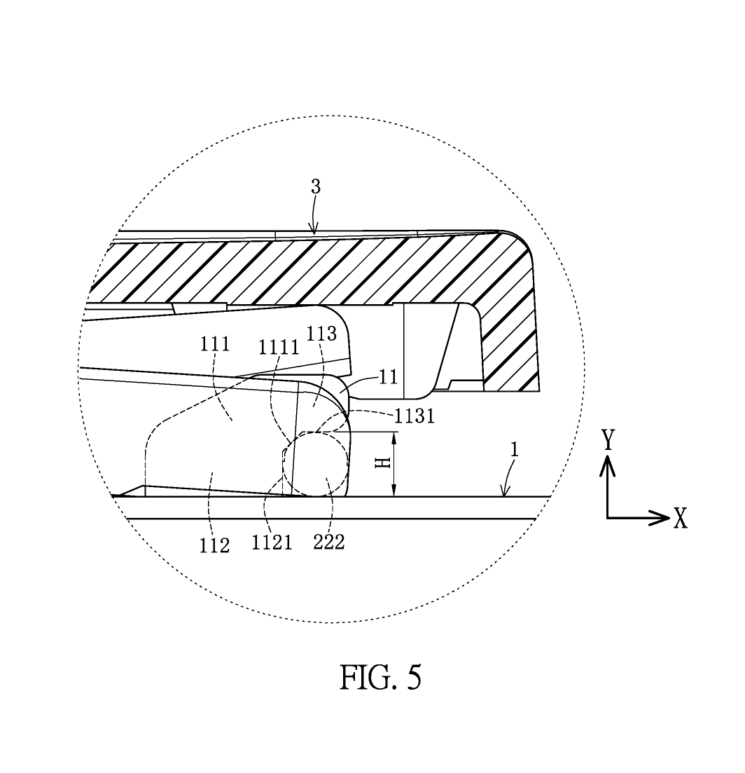

With reference to FIG. 5, in one embodiment of the present disclosure, the snap-fit hook 11 includes a base portion 112 and a supporting portion 113 extending upwards from the base portion 112. The chamfer structure 111 is formed between the base portion 112 and the supporting portion 113. More specifically, the base portion 112, the supporting portion 113, and the chamfer structure 111 respectively includes a vertical surface 1121 (or a vertical side), a supporting surface 1131 (or a supporting side), and a chamfer surface 1111 (or a chamfer side). The supporting surface 1131 is approximately perpendicular to the vertical surface 1121. The angle between the supporting surface 1131 and the chamfer surface 1111 and that between the vertical surface 1121 and the chamfer surface 1111 are approximately 135 degrees. Accordingly, the chamfer angle of the chamfer surface 1111 is approximately 45 degrees.

A height H of the supporting portion 113 (or a height of the snap-fit hook 11) is equal to a height of the pivot shaft 222 and is defined as the distance between the supporting surface 1131 and an upper surface of the base plate 1. With the aforementioned structure, the pivot shaft 222 abuts the supporting surface 1131 of the supporting portion 113.

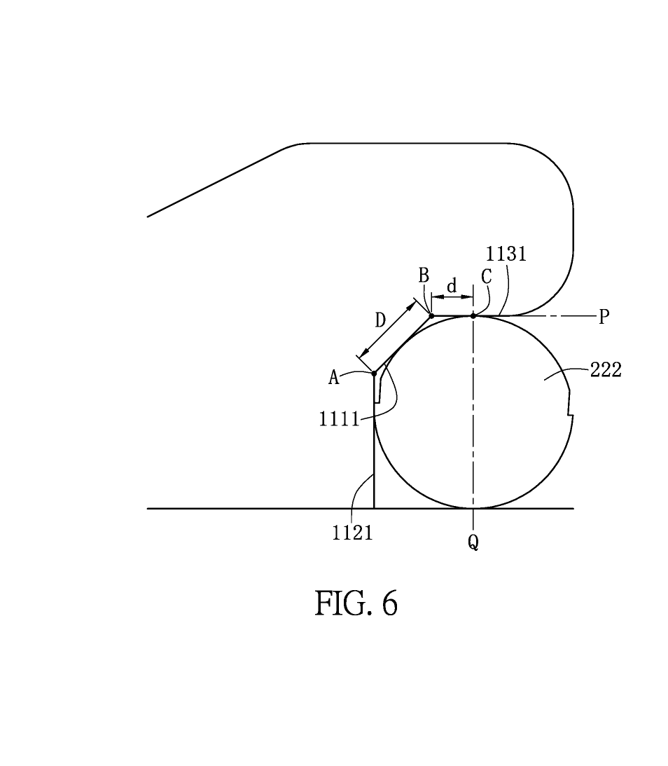

Specifically, referring to FIG. 6, the point where the vertical surface 1121 and the chamfer surface 1111 meet is defined as a first corner point A, and the point where the chamfer surface 1111 and the supporting surface 1131 meet is defined as a second corner point B. The point where the perpendicular bisector Q of the pivot shaft 222 intersects the horizontal line P passing through the second corner point B is defined as an intersection point C. The distance between the first corner point A and the second corner point B is defined as a first length D, and the distance between the second corner point B and the intersection point C is defined as a second length d. When the snap-fit hook 11 has no tolerance variations, there will not be a vertical gap between the supporting surface 1131 and the pivot shaft 222. In addition, the first length D will be twice as long as the second length d.

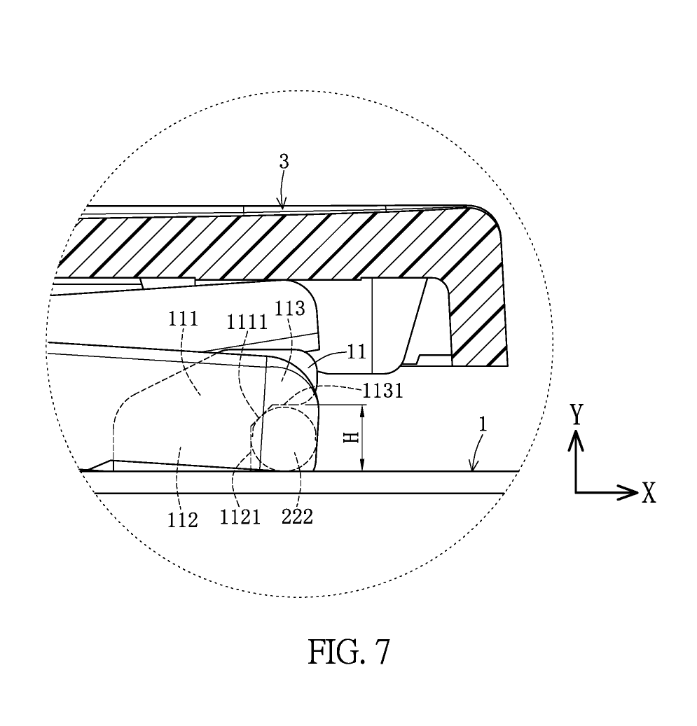

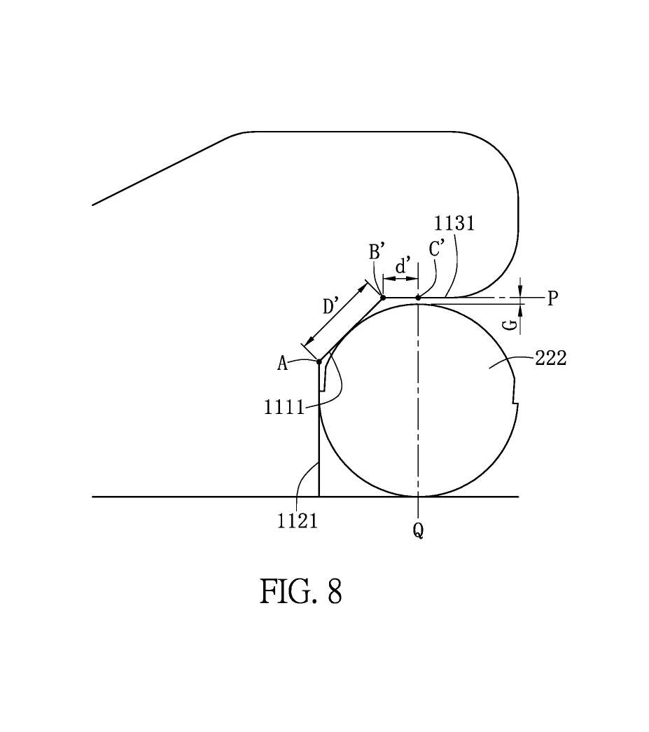

With reference to FIGS. 7 and 8, in another embodiment of the present disclosure, the point where the vertical surface 1121 and the chamfer surface 1111 meet is defined as a first corner point A, and the point where the chamfer surface 1111 and the supporting surface 1131 meet is defined as a second corner point B′. The point where the perpendicular bisector Q of the pivot shaft 222 intersects the horizontal line P passing through the second corner point B′ is defined as an intersection point C′. The distance between the first corner point A and the second corner point B′ is defined as a first length D′, and the distance between the second corner point B′ and the intersection point C′ is defined as a second length d′. When the snap-fit hook 11 has tolerance variations, there exists a vertical gap G between the supporting surface 1131 and the pivot shaft 222. Under this condition, the distance between the first corner point A and the second corner point B′ is the first length D′, in which the first length D′ is greater than the first length D shown in FIG. 6. In addition, the distance between the second corner point B′ and the intersection point C′ is the second length d′, in which the second length d′ is smaller than the second length d shown in FIG. 6. Furthermore, the first length D′ will be longer than twice the second length d′.

According to another embodiment of the present disclosure, a height of the supporting portion 113 is smaller than a height of the pivot shaft 222.

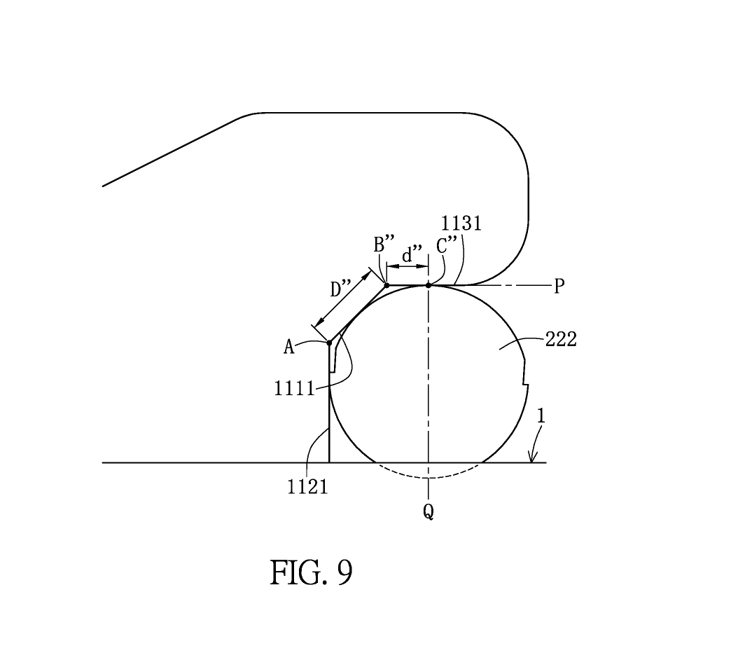

Specifically, with reference to FIG. 9, in another embodiment of the present disclosure, the point where the vertical surface 1121 and the chamfer surface 1111 meet is defined as a first corner point A, and the point where the chamfer surface 1111 and the supporting surface 1131 meet is defined as a second corner point B″. The point where the perpendicular bisector Q of the pivot shaft 222 intersects the horizontal line P passing through the second corner point B″ is defined as an intersection point C″. The distance between the first corner point A and the second corner point B″ is defined as a first length D″, and the distance between the second corner point B″ and the intersection point C″ is defined as a second length d″. The height of the supporting portion is smaller than the height of the pivot shaft. The distance between the first corner point A and the second corner point B″ is the first length D″, in which the first length D″ is greater than the first length D shown in FIG. 6. In addition, the distance between the second corner point B′ and the intersection point C′ is the second length d′, in which the second length d′ is greater than the second length d shown in FIG. 6.

In general, due to the tolerance variations of the snap-fit hook 11, there may be a gap between the supporting surface 1131 and the pivot shaft 222 such that a bottom of the keycap 3 moves unstably when the keycap 3 is pressed. The pivot shaft 222 of the present disclosure abuts the chamfer surface 1111 of the chamfer structure 111 by being in point contact therewith, reducing or eliminating the unstable actuation of the bottom of the keycap 3. According to the measurements performed on the embodiments of the present disclosure, the distance that the bottom of the keycap 3 moves decreases approximately from 0.2 mm to 0.1 mm, reducing the unstable movement of the bottom of the keycap 3 by 50 percent compared to key assemblies available on the market.

In summary, in the present disclosure, the snap-fit hook 11 includes a chamfer structure 111 at a bending portion thereof, and the pivot shaft 222 is pivotally connected to the snap-fit hook 11 and abuts the chamfer structure 111 by being in point contact therewith so as to compensate the gap between the snap-fit hook 11 and the pivot shaft 222, thereby reducing the unstable movements at the bottom of the keycap 3 while enabling the key assembly to use components with conventional tolerance dimensions. By the aforementioned structural means, the manpower and manufacturing costs spent on constantly making new molds in order to reduce the gap or produce a precise chamfer angle can be saved.

The description illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A key assembly to be installed on a keyboard, the key assembly comprising:
a base plate including a snap-fit hook;
a scissor member including a pivot shaft; and
a keycap, the keycap being disposed on the scissor member and connected thereto, the scissor member being disposed on the base plate and connected thereto,
wherein the snap-fit hook has a chamfer structure at a bending portion thereof, the pivot shaft being pivotally connected to the snap-fit hook and abutting the chamfer structure by being in point contact therewith in such a manner that the vertical gap between the snap-fit hook and the pivot shaft is reduced.

2. The key assembly according to claim 1, wherein the base plate includes a fixing end and a sliding end disposed on opposite sides thereof, wherein the snap-fit hook is located at the fixing end.

3. The key assembly according to claim 1, wherein the snap-fit hook is formed by a stamping process into an upside-down L shape, the snap-fit hook being protruded from the base plate and integrally connected thereto.

4. The key assembly according to claim 3, wherein the snap-fit hook includes a base portion and a supporting portion extending upwards from the base portion.

5. The key assembly according to claim 4, wherein the base portion, the supporting portion, and the chamfer structure respectively include a vertical surface, a supporting surface, and a chamfer surface, the supporting surface being perpendicular to the vertical surface, the angle between the supporting surface and the chamfer surface and that between the chamfer surface and the vertical surface being approximately 135 degrees so that the chamfer angle of the chamfer surface is approximately 45 degrees.

6. The key assembly according to claim 5, wherein a height of the supporting portion is equal to a height of the pivot shaft and is defined as the distance between the supporting surface and an upper surface of the base plate.

7. The key assembly according to claim 6, wherein the point where the vertical surface and the chamfer surface meet is defined as a first corner point, the point where the chamfer surface and the supporting surface meet is defined as a second corner point, and the perpendicular bisector Q of the pivot shaft intersecting the horizontal line passes through the second corner point at an intersection point, in which the distance between the first corner point and the second corner point is defined as a first length, the distance between the second corner point and the intersection point is defined as a second length, the first length being twice as long as the second length.

8. The key assembly according to claim 5, wherein a height of the supporting portion is greater than a height of the pivot shaft, in which the height of the supporting portion is defined as the distance between the supporting surface and an upper surface of the base plate.

9. The key assembly according to claim 8, wherein the point where the vertical surface and the chamfer surface meet is defined as a first corner point, the point where the chamfer surface and the supporting surface meet is defined as a second corner point, and the perpendicular bisector Q of the pivot shaft intersecting the horizontal line passes through the second corner point at an intersection point, in which the distance between the first corner point and the second corner point is defined as a first length, and the distance between the second corner point and the intersection point is defined as a second length, the first length being twice greater than the second length.

10. The key assembly according to claim 5, wherein a height of the supporting portion is smaller than a height of the pivot shaft.
